(19) United States
(12) Patent Application Publication
(10) Pub. No.: US 2021/0131147 A1
(43) Pub. Date: May 6, 2021

(54) Locking System for Containers

(71) Applicant: Sprout Studios LLC, Boston, MA (US)

(72) Inventors: Jordan Nollman, Boston, MA (US); Richard Orsini, Boston, MA (US); Benjamin Lenart, Boston, MA (US); Zachary Porter, Boston, MA (US)

(21) Appl. No.: 17/084,858

(22) Filed: Oct. 30, 2020

Related U.S. Application Data
(60) Provisional application No. 62/928,176, filed on Oct. 30, 2019.

(51) Int. Cl. E05B 73/00; E05B 47/00; E05B 39/00; E05B 39/04; G08C 17/02

(52) U.S. Cl. CPC E05B 73/00; E05B 47/0001; G01S 19/42; E05B 39/04; G08C 17/02; E05B 39/005

(57) ABSTRACT

A locking device including a body, a first bar member, a second bar member, a hinge wherein the hinge is disposed to link the first bar member and the second bar member to facilitate mounting and removal of the lock, a magnet disposed to be secure the lock body to a metal portion of a container lid, an actuation button, an electromechanical locking mechanism including a bar member, a pivoting cache, a support plate, an internal latch, an internal motor, a rotational hinge is provided. Further controlling and monitoring the electromechanical lock is achieved through a mobile device in data communication with the lock and an Internet cloud service.

### CROSS REFERENCE TO RELATED APPLICATION

This application claims the benefit of and takes priority from U.S. Provisional Patent Application Ser. No. 62/928,176 filed on Oct. 30, 2019, the contents of which are herein incorporated by reference.

### FIELD OF THE INVENTION

The present system relates to locking systems for containment systems and more particularly for local and remote locking devices for jars and electronically controlled.

### BACKGROUND OF THE INVENTION

The present disclosure relates to access control for personal secured containers, and more specifically to electronic access control mechanisms which may be locked or unlocked on station or remotely using commands issued from a portable electronic device, website, or other computer device. Remote access is established in wireless security systems through means of software, Remote Frequency Identification (RFID), Near Field Communications (NFC), Bluetooth®, Zigbee® or other means of short-range wireless protocol. Non-limiting examples of a computer device may include but are not limited to a laptop Personal Computer (PC), a desktop PC, a tablet PC, a smart phone, a mobile phone, or Personal Digital Assistant.

### SUMMARY OF THE INVENTION

The instant apparatus and system, as illustrated herein, is clearly not anticipated, rendered obvious, or even present in any of the prior art mechanisms, either alone or in any combination thereof. A versatile system, method and series of apparatuses for creating and utilizing numerous locking mechanisms for containment systems. Thus the several embodiments of the instant apparatus are illustrated herein.

In this specification, a “user” is anyone interacting with the locking system or web service, including a person operating a portable electronic device as described herein. The words “user” and “device” (or “portable electronic device”) are in some cases used interchangeably, since the device is carried and operated by the user.

A “locking system” or “lock system” includes a “lock”, and the terms are sometimes used interchangeably. Configuration, description, use or claims to a “locking system” or “lock system” includes configuration, description, use or claims to a “lock” accordingly.

It is therefore an objective of the instant system to introduce a novel system or platform for security of a containment vessel.

It is an additional objective of the instant system to introduce a novel system or platform for remotely accessible security of a containment vessel.

It is further objective of the instant system to introduce a novel system or platform for locking of a containment vessel.

It is also an objective of the instant system to introduce a novel system or platform for security of genres of containment systems, of all shapes and sizes.

It is also an objective of the instant system to introduce a novel system or platform for security of all genres of containment systems such all shapes and sizes of jars and jars with lids, including small, medium and large mouth jars with lids.

It is additionally an objective of the instant system introduce a novel system or platform for security of a standard mason jar and lid.

It is moreover an objective of the instant system to introduce a novel system or platform for security of a wide mouth mason jar and lid.

An additional objective of the instant system is the introduction of novel system or platform for remotely accessing a system for locking of a containment vessel via electronic means Including software or mobile based activity.

It is moreover an objective of the instant system introduce system to securely store all kinds of materials, in a manner wherein children, animals and unwanted people are flatly denied access to the contents of a container, which is specifically suited to such substances as cannabis.

There has thus been outlined, rather broadly, the more important features of the mobile application system for controlling the opening, closing and general security of containers, in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction and to the arrangements of the components set forth in the following description, and/or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

The foregoing has outlined the more pertinent and important features of the present system in order that the detailed description of the system that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

### BRIEF DESCRIPTION OF THE DRAWINGS

The invention may be more completely understood in consideration of the following detailed description of various embodiments of the invention in connection with the accompanying drawings, in which:

FIG. 1 illustrates one embodiment of the instant system comprising an electromechanical lock for containers including wide mouth mason jars;

FIG. 2 illustrates an embodiment of a system for wirelessly controlling and monitoring an electromechanical lock through a mobile device in data communication with the lock and an Internet cloud service;

FIGS. 3-5 illustrate an embodiment of the internal electromechanical locking mechanism actuated by the associated mobile device;

FIG. 6 illustrates an embodiment of the electromechanical lock in the closed position and the open position;

FIGS. 7 and 8 illustrate an embodiment of an associated mobile application for managing and controlling the electromechanical jar lock;

FIG. 9 illustrates a flow diagram for a user login and home screen for the associated mobile application;

FIG. 10 illustrates a flow diagram for loading items into a jar and securing the lock to the jar; and

FIG. 11 illustrates a flow diagram for unlocking the jar.

### DETAILED DESCRIPTION OF THE SEVERAL EMBODIMENTS

The detailed description set forth below in connection with the appended drawings is intended as a description of several embodiments of the apparatus and does not represent the only forms in which the present apparatus may be constructed and/or utilized. The description sets forth the functions and the sequence of steps for constructing and operating the apparatus in connection with the illustrated embodiments. However, it is to be understood that the same or equivalent functions and sequences may be accomplished by different embodiments that are also intended to be encompassed within the spirit and scope of the invention.

For the following defined terms, these definitions shall be applied, unless a different definition is given in the claims or elsewhere in this specification. All numeric values are herein assumed to be modified by the term “about”, whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following description should be read with reference to the drawings wherein like reference numerals indicate like elements throughout the several views. The drawings, which are not necessarily to scale, depict illustrative embodiments of the claimed invention.

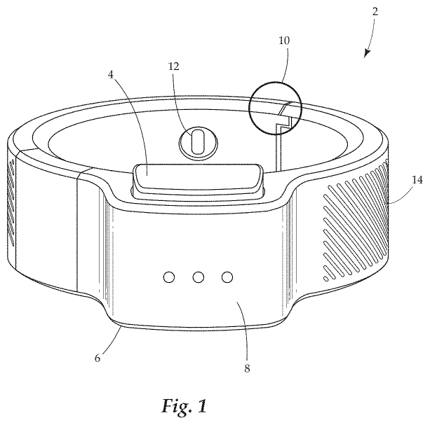

FIG. 1 illustrates one embodiment of an electromechanical locking device 2 for containers and specifically jar type containers and wide mouth mason jars. The locking device 2 may be disposed to fit circumferentially over the top of the container to secure the lid so it cannot be removed without first removing the lock device 2. Both mechanical and electric components are involved in locking and unlocking the locking device 2.

Electrical components are housed within the device and function to communicate with a mobile device, store power, and operate the internal locking mechanism for a first stage of unlocking, described further below.

In one embodiment, an actuation button 4 operates a second stage of unlocking after the internal locking mechanism is actuated by the electrical components. It will be appreciated that the specific mechanisms for each stage of locking/unlocking are possible configurations and are not limiting. Many electric and mechanical mechanisms could accomplish the objectives of the present invention.

The lock body 6 houses additional electric components including LED indicators 8, speakers, and servos or accelerometers. In one embodiment, the front of the housing, under the actuation button 4 or other mechanical locking and unlocking mechanism, displays LED indicators 8 that signal the user to various actions undertaken by the lock or associated system. The lock body 6 may be composed of numerous materials within the state of the art, including polymeric, metallic, composites and combinations thereof.

Bluetooth® devices commonly utilize LED indicators to assist the user in pairing the device to a mobile phone or other associated Bluetooth® capable device. Speakers within the plastic housing provide audible feedback to the user. Opening and closing the lock triggers the speakers to signal the completion of an action by emitting a tone or verbal response. In addition, the speakers emit a tone upon any tampering activity or unsuccessful opening attempts.

Thus, a user can remotely trigger the alarm from their mobile device and alarm tones increase security along with the physical features described in this application. The plastic housing may also include a plurality of accelerometers. The system can alert a user upon any movement sensed by the accelerometers within the lock body 6. A user can choose, for example, for the system to alert them whenever the accelerometers sense movement when the user's mobile device is not detected.

The electromechanical jar lock includes a plurality of elements to facilitate easier mounting and removal of the lock. Located on the opposing side of the locking mechanism is a hinge 10 to facilitate mounting and removal of the lock. A benefit of this embodiment is reducing torsional tension that could potentially affect the integrity of the plastic lock body at the point of torsion leading to breakage. A magnet 12 on the lock's inner surface secures the lock to the metal comprising the mason jar lid. Fixation of the magnet on the lock's inner ring allows the lock to spontaneously position itself correctly with respect to the lid, thus increasing ease of use and safety for the user.

This configuration limits the possibility for mishandling the device, jar, or the enclosed contents and speeds up the locking/unlocking process overall. In one embodiment, the exterior surface of the lock includes gripping elements 14 to further facilitate the mounting and removal of the lock. Plastic normally has a greater risk of slippage compared to other materials like rubber, for example. Ridges, or other similar gripping and holding elements, assist the user in maintaining secure grip while handling the jar. Because the device is directed for use on glass jars, additional elements to prevent slippage or drops are highly desirable.

In one embodiment, the lock includes external features to increase security and ease of use. The device may be configured to be compatible with a Kensington® Lock. A loop of rubberized metal cable attaches to the lock to be thread through a stationary object, preventing unwanted removal of the lock and jar. In one embodiment, the lock includes a lanyard for ease and security of transportation.

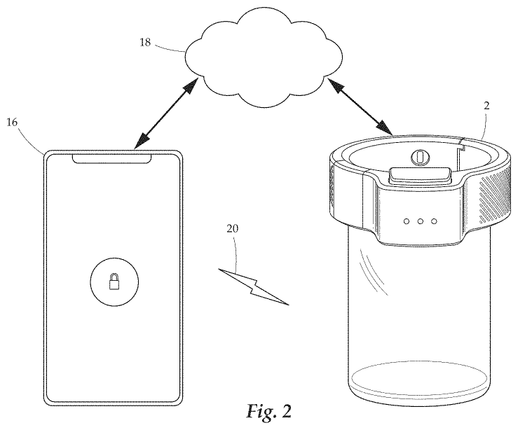

FIG. 2 illustrates an embodiment of a system for wirelessly controlling and monitoring an electromechanical lock 2 through a mobile device 16 in data communication with the lock and an Internet cloud service 18. The system includes the electromechanical locking device 2 designed to be disposed over the lid of a wide mouth mason jar. The electromechanical locking device 2 may contain a communication and control module incorporated within the device configured to wirelessly communicate with a mobile device.

Wherein numerous variants and embodiments of electrical, mechanical and electromechanical locking devices may be discussed and illustrated herein, it should be understood that the instant system is in no way limited to the systems set out herein, or limited to the current state of the art.

A user initiates the unlock procedure through the associated mobile device. The NFC enabled mobile device must first be held in close proximity to the electromechanical lock in order to sense the NFC tag embedded in the plastic lock body. Reading the imbedded NFC tag launches the associated application on the mobile device or, if the application is already open, initiates the unlocking process. The mobile device communicates user credentials and unique NFC identifier from the lock to an Internet cloud service. Confirmation of the credentials by the Internet cloud service initiates the unlocking of the device.

When the mobile device is in proximity of the lock, it establishes a wireless connection with the communication and control module, for example via a short-range wireless protocol, such as Bluetooth®, Wi-Fi, Zigbee®, Z-wave, or the like. In an embodiment, the mobile device commences establishing a wireless connection with the lock upon receiving user input from a user interface displayed on the mobile device (e.g., when the user presses a start button via the user interface to establish a connection to a listed lock). In another embodiment, the mobile device automatically establishes a wireless connection to communication and control module of the lock upon detecting its proximity, for example via automatic Bluetooth® pairing when the lock has been pre-configured in the lock database stored in the mobile device.

The mobile device 16 must also be capable of passively reading a Near Field Connection (NFC) tag. The electromechanical locking device 2 provides inductive power 20 to the NFC tag. The NFC tag responds with a static Universal Resource Indicator (URI) encoded in such a way as to launch an unlock sequence on the electronic device. The URI also codes for a unique identifier string unique to each tag. The application then passes the user id and unique identifier string to a cloud service 18. The cloud service 18 authenticates the credentials, and performs an action associated with the unique tag identifier, or based on a command issued by a user as input on the portable electronic device. The action or command is performed on a lock or lock server associated with the tag identifier to actuate the lock. The server sends a confirmation of the action performed to the electronic device.

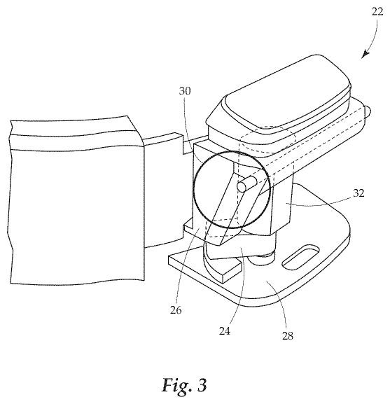

FIGS. 3-5 illustrate an embodiment of the internal electromechanical locking mechanism 22 actuated by the associated mobile device. The internal locking mechanism 22 comprises electric and mechanical components actuated in a stepwise fashion. First, the electric components must rotate an internal mechanism to free the manual actuation button 4 to move. Then the user depresses the actuation button 4 which releases a latch, allowing the two halves of the lock to separate.

The lock body contains the internal locking mechanism in the protruded portion of the jar lock under the manual actuation button 4. In the locked state, a bar 24 jams the manual portion of the mechanism to prevent actuation of the actuation button 4 by maintaining contact with a pivoting cache 26 and a support plate 28. The pivoting cache 26 prevents separation of the two halves of the lock body. A lower portion of the pivoting cache 26 remains in contact with an internal latch 30 until the actuation button 4 is actuated, preventing removal of the latch from the locking mechanism.

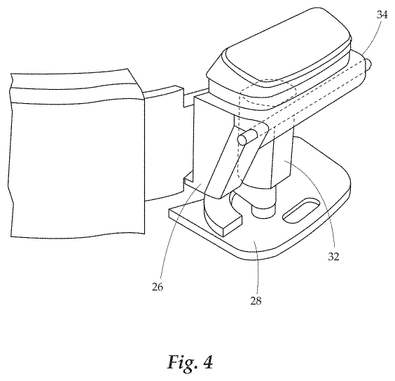

Regarding FIG. 4, once unlocking is initiated successfully, an internal motor 32 rotates the bar out of contact with the pivoting cache and support plate. The pivoting cache 26 is now free to rotate along a rotational hinge 34 connecting the pivoting cache to the lock body until the lower portion of the pivoting cache 26 abuts the support plate 28.

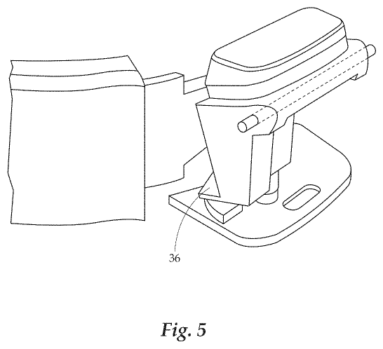

FIG. 5 shows the lower portion of the pivoting cache 26 no longer contacts the internal latch 36. The second half of the lock can be separated from the first half at the protruded portion of the plastic lock body, opening the jar lock and allowing a user to access the jar's contents.

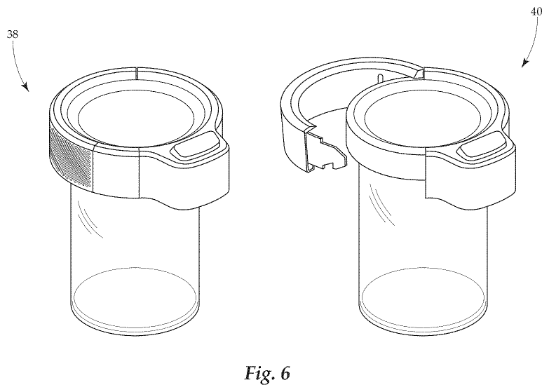

FIG. 6 illustrates an embodiment of the electromechanical lock in the closed position 38 and the open position 40. After actuation of the manual locking components, the first bar member 50 and the second bar member 52 are separated to manipulate the locking device 2 into the open position. A magnet ensures the jar lock is not totally removed from the jar prior to the user actually removing it, preventing unintentional mishandling or accidental drops.

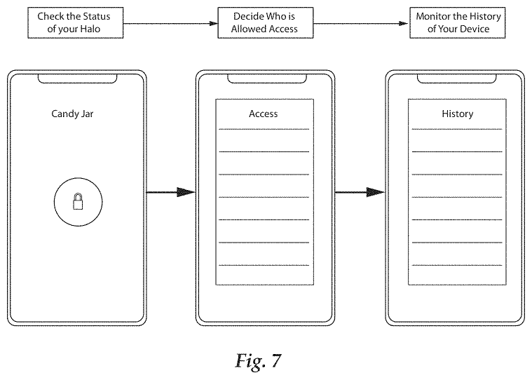

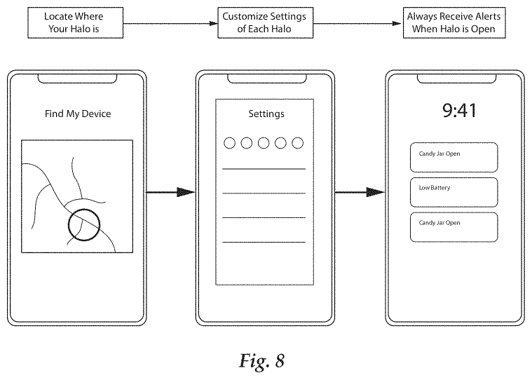

FIGS. 7 and 8 illustrate an embodiment of an associated mobile application for managing and controlling the electromechanical jar lock.

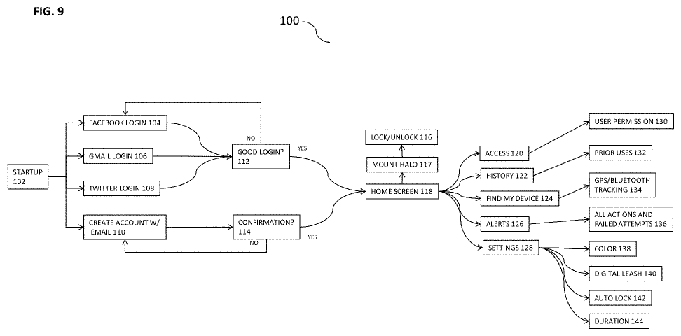

FIG. 9 illustrates a flow diagram 100 for a user login and home screen for the associated mobile application. After downloading the application, a user must sign up with the system and register with a new account. On first use of the system, the user opens the application on their associated mobile device at the first step 102 startup. A user can select a method to login through linking their Halo account to a number of popular social networking accounts. A user can choose to link a Facebook account 104, Google Mail account 106, or Twitter account 108. Alternatively, a user may link their Halo account directly to a third-party email account 110 to complete registration. Once registration is completed a user can simply select the appropriate associated account to login on system startup 102.

Alternatively, the system can remember the user credentials to automatically bring a user to the home page upon startup 102. As previously described, a user can lock and unlock their Halo from the home screen. Tabs along the bottom of the home screen lead a user to the remaining functions within the mobile application from the access tab 120, a user can view and control what additional users have control over the linked Halo device. The main user can control the permissions each satellite user may exercise. A user can view who has had access to their “Halo” and when through the device History 122.

Next, selecting Find my Device 124 allows a user to access location data based on the GPS and Bluetooth® tracking capabilities imbedded in the device and described herein. A user can also customize and view current and past Alerts 126 related to all actions taken by the user and system. This includes everything from each instance of locking/unlocking, failed attempts, location history, unauthorized access or movement alerts, and more.

All alerts are customizable so a user can see as many or as few as desired. Lastly a user can manage all Settings 128 within the system and application. A user can manage the color 138 of the Halo on the home screen, presence and circumference of a digital leash 140, time period to initiate automatic locking 142 procedures, and duration 144 for alerts.

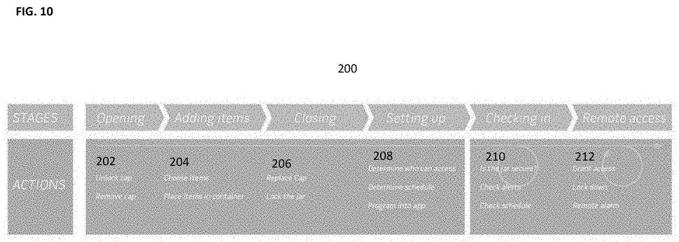

FIG. 10 illustrates a flow diagram 200 for loading items into a jar and securing the lock to the jar. The mobile device reads the NFC tag imbedded in the plastic lock body to open the device at step 202. Once the electric mechanism unlocks, the user removes the lock 202 by depressing the manual actuation button and separating the two halves of the lock. Next the user loads items into the jar 204 and mounts the lock on the jar 206 by inserting the locking latch into the locking mechanism beneath the actuation button. The mobile device application can then lock the device 206 and control all settings 208, as previously described. A user can also use the application to monitor 210 their locking device and remotely control all security features 212.

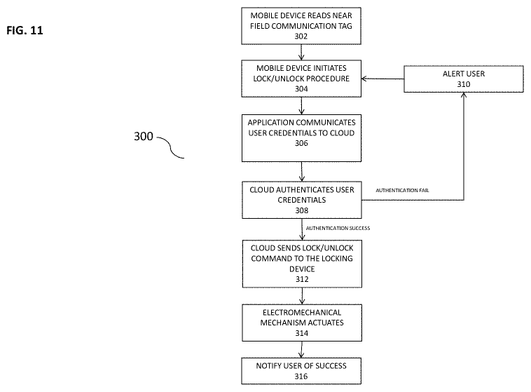

FIG. 11 illustrates a flow diagram 300 for unlocking the jar. At step 302 the user reads a Near Field Communication tag with their mobile electronic device. The NFC tag is encoded with an application URI and unique code. Generally, a system level interface will automatically read any sufficiently near tags with system level protocols. The electronic device recognizes the URI file type descriptor and launches the appropriate procedure associated with the unique identifier tag. The mobile device then initiates the lock actuation procedure 304.

The application will notify an Internet cloud service 306 that it has read a tag and pass along the associated unique id of that NFC tag. The web service will authenticate the application 308 to verify that the read request came from a valid, signed in account. If the request is deemed to be invalid, the application will be notified 310. If however the request is valid, the web server will pass a request corresponding to the locking device associated with the NFC tag. The request could be a lock request, a timed unlock request, or a toggle request (issue the opposite request as previously sent) Next, the application will issue a command to the device to initiate a lock or unlock request 312 with the lock. In 314 the lock would actuate. If the lock actuated successfully, the cloud service would notify the web server which would notify the lock application 316.

What is claimed is:

1. A locking device comprising:
a locking device body;
a first bar member and a second bar member;
a hinge wherein the hinge is disposed to link the first bar member and the second bar member to facilitate mounting and removal of the lock;
a magnet wherein the magnet is secured to the inner surface of the lock body and wherein the magnet is disposed to secure the lock body to a metal portion of a mason jar lid;
an actuation button wherein the actuation button operates a second stage of unlocking after the internal locking mechanism is actuated by the electrical components; and
an electromechanical locking mechanism.

2. The locking device of claim 1 wherein the locking device body disposed to fit circumferentially over the top of the container to secure the lid so it cannot be removed without first removing the lock.

3. The locking device of claim 1 further comprising a system for wirelessly controlling and monitoring the electromechanical locking mechanism utilizing a mobile device in data communication with the lock and an Internet cloud service.

4. The locking device of claim 1 further comprising a system for to accessing location data based on the GPS and Bluetooth® tracking capabilities imbedded in the device and described herein.

5. The locking device of claim 1 further comprising a system for creating and utilizing alerts wherein a user customizes and views current and past alerts related to all actions taken by the user and system.

6. The locking device of claim 5 wherein the actions taken by the user include actions selected from the group consisting of each instance of locking/unlocking, failed attempts, location history, unauthorized access and movement alerts.

7. The locking device of claim 1, wherein the electromechanical mechanism further comprises:
a bar member;
a pivoting cache;
a support plate;
an internal latch;
an internal motor; and
a rotational hinge.

8. The locking device of claim 7, wherein the bar member is disposed to jam the manual portion of the lock mechanism to prevent actuation of the actuation button by maintaining contact with the pivoting cache and the support plate.

9. The locking device of claim 7, wherein the pivoting cache prevents separation of the two halves of the lock body and wherein the lower portion of the pivoting cache remains in contact with the internal latch until the manual actuation button is actuated, preventing removal of the latch from the locking mechanism.

10. The locking device of claim 7, wherein once unlocking is initiated successfully, the internal motor rotates the bar out of contact with the pivoting cache and support plate and the pivoting cache is now free to rotate along the rotational hinge connecting the pivoting cache to the lock body until the lower portion of the pivoting cache abuts the support plate.
